(19) United States
(12) Patent Application Publication
(10) Pub. No.: US 2007/0180010 A1
(43) Pub. Date: Aug. 2, 2007

(54) System and method for iteratively eliminating common subexpressions in an arithmetic system

(75) Inventors: Farzan Fallah, San Jose, CA (US); Anup Hosangadi, Goleta, CA (US); Ryan C. Kastner, Carpinteria, CA (US)

Correspondence Address: BAKER BOTTS L.L.P., 2001 ROSS AVENUE, SUITE 600, DALLAS, TX, 75201-2980, US

(73) Assignees: Fujitsu Limited; University of California, Santa Barbara, CA (US)

(21) Appl. No.: 11/331,895

(22) Filed: Jan. 13, 2006

(51) Int. Cl. G06F 17/14

(52) U.S. Cl. 708/400

(57) ABSTRACT

A method for reducing operations in a processing environment is provided that includes generating one or more binary representations. One or more of the binary representations are included in one or more linear equations that include one or more operations. The method also includes converting one or more of the linear equations to one or more polynomials and identifying one or more common subexpressions associated with the polynomials in order to reduce one or more of the operations. The identifying step is facilitated by an algorithm that iteratively selects divisors and then uses the divisors to eliminate common subexpressions among the linear equations. The method can also take into account the delay of expressions while performing the optimization. Further, it can optimize a polynomial to reduce the number of operations. Additionally, it can optimize the exponents of variables.

### TECHNICAL FIELD OF THE INVENTION

The present invention relates generally to digital signal processor (DSP) design and, more particularly, to a system and a method for iteratively eliminating common subexpressions in an arithmetic system.

### BACKGROUND OF THE INVENTION

The proliferation of integrated circuits has placed increasing demands on the design of digital systems included in many devices, components, and architectures. The number of digital systems that include integrated circuits continues to steadily increase and may be driven by a wide array of products and systems. Added functionalities may be implemented in integrated circuits in order to execute additional tasks or to effectuate more sophisticated operations in their respective applications or environments.

In the context of processing, present generation embedded systems have stringent requirements on performance and power consumption. Many embedded systems employ digital signal processing (DSP) algorithms for communications, image processing, video processing etc, which can be computationally intensive. These algorithms each include and implicate any number of processing operations. The required processing operations (e.g. multiplication, addition, shift, etc.) are paramount in any proposed processing optimization. Moreover, it is the operations that dictate the demands, capacity, and capabilities of any given system architecture or configuration. Accordingly, the ability to reduce these operations to achieve optimal processing provides a significant challenge to system designers and component manufacturers alike.

### SUMMARY OF THE INVENTION

From the foregoing, it may be appreciated by those skilled in the art that a need has arisen for an improved processing approach for minimizing the number of operations. In accordance with the present invention, techniques for reducing operations in an arithmetic system are provided. According to specific embodiments, these techniques can optimize a given set of equations by eliminating any number of common subexpressions involving single or multiple variables.

According to a particular embodiment, a method for reducing operations in a processing environment is provided that includes generating one or more binary representations. One or more of the binary representations are included in one or more linear equations that include one or more operations. The method also includes converting one or more of the linear equations to one or more polynomials and identifying one or more common subexpressions associated with the polynomials in order to reduce one or more of the operations. The identifying step is facilitated by an algorithm that iteratively selects divisors and then uses the divisors to eliminate common subexpressions among the linear equations.

In more particular embodiments, at least one of the divisors is a two-term divisor. Additionally, in more specific embodiments, a delay of calculating expressions is evaluated when the optimization is performed. In alternative embodiments, instead of the linear equations, a set of polynomials are optimized. In another embodiment, the exponents of a single or multiple variables in one or several polynomials are optimized.

Embodiments of the invention may provide various technical advantages. Certain embodiments provide for a significant reduction in operations for an associated processing architecture. This is a result of a new iterative process to find common subexpressions involving multiple variables for the linear systems. The technique offers an implementation with a minimal number of additions/subtractions (and/or shifts), in contrast to other techniques. Synthesis results, on a subset of these examples, reflect an implementation with less area and faster throughput in comparison to conventional techniques. Hence, the present invention can achieve a saving in operations, which provides for less power consumption and smaller area configurations. Such an approach may be ideal for the design of digital signal processing hardware or other applications, as outlined herein.

Other technical advantages of the present invention may be readily apparent to one skilled in the art. Moreover, while specific advantages have been enumerated above, various embodiments of the invention may have none, some, or all of these advantages.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates a digital signal processor (DSP) system for iteratively eliminating common subexpressions according to various embodiments of the present invention;

FIG. 2 is a simplified diagram that illustrates some example common subexpressions to be processed by the present invention;

FIG. 3 is a simplified diagram that illustrates a linear term, which can be converted into a polynomial;

FIG. 4 is a simplified diagram that illustrates one iteration of an example algorithm in accordance with one embodiment of the present invention;

FIG. 5 is a simplified diagram that illustrates a subsequent iteration in the proposed algorithm of FIG. 4;

FIG. 6 is a simplified diagram that illustrates a subsequent step in the algorithm;

FIG. 7 is yet another simplified diagram that illustrates a subsequent step in the algorithm; and

FIG. 8 is a simplified diagram that illustrates an example result for the algorithm.

### DETAILED DESCRIPTION OF THE DRAWINGS

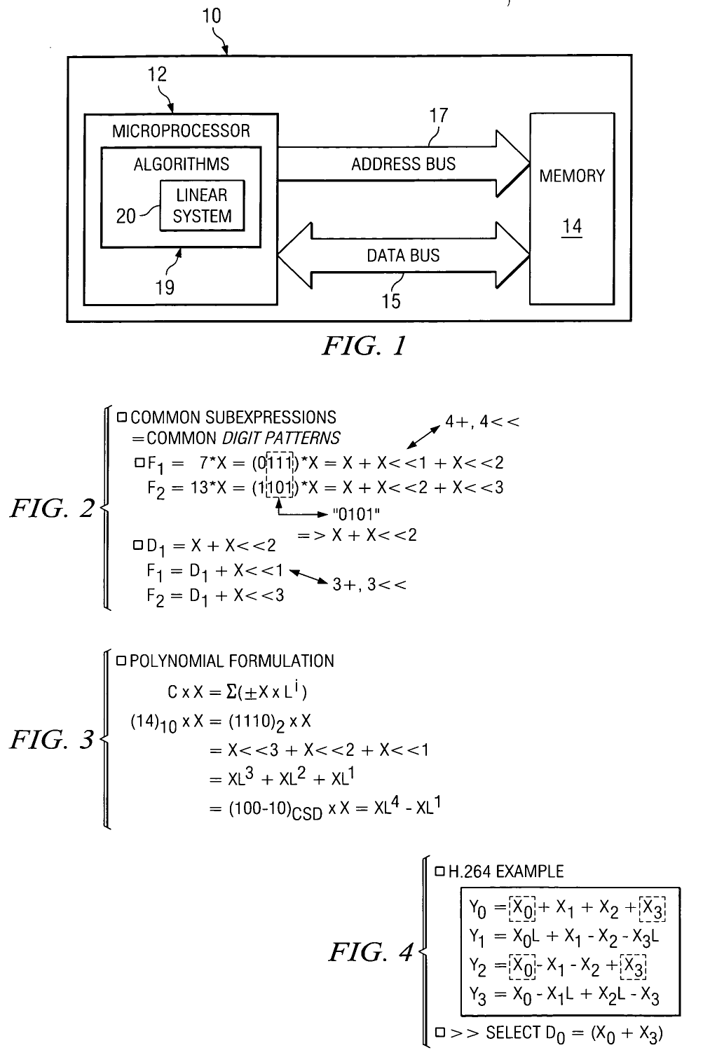

FIG. 1 is an example of a system that could use the algorithms that we have invented, which are included as “algorithms 19.” FIG. 1 is a portion of a system 10 that operates in a digital signal processor (DSP) environment. System 10 includes a microprocessor 12 and a memory 14 coupled to each other using an address bus 17 and a data bus 15. Microprocessor 12 includes one or more algorithms 19, which include a linear system 20.

In accordance with the teachings of the present invention, algorithm 19 operates to optimize linear systems 20, which may be used in the signal processing. In general, “linear systems” are widely used in signal processing, for example, in the context of: Discrete Cosine Transform (DCT), Inverse Discrete Cosine Transform (IDCT), Discrete Fourier Transform (DFT), Discrete Sine Transform (DST), and Discrete

Hartley Transform (DHT). System 10 performs a common subexpression elimination that involves multiple variables and that is applicable to any of these technologies.

Common subexpression elimination is commonly employed to reduce the number of operations in DSP algorithms, for example after decomposing constant multiplications into shifts and additions. Conventional optimization techniques for finding common subexpressions can optimize constant multiplications, but they miss many optimization opportunities. Algorithm 19 transforms computations such that all possible common subexpressions involving any number of variables can be detected. Algorithms can then be presented in order to select a good set of common subexpressions. The technique can be used to find common subexpressions in any kind of linear computations, where there are a number of multiplications with constants involving any number of variables. Synthesis results for system 10 yield an implementation with less area and higher throughput, as compared to conventional techniques. Finding common subexpressions in the set of additions further reduces the complexity of the implementation. Additional details relating to this process are provided below with reference to subsequent FIGURES.

Referring back to FIG. 1, microprocessor 12 may be included in any appropriate arrangement and, further, include algorithms 19 embodied in any suitable form (e.g. software, hardware, etc.). For example, microprocessor 12 may be part of a simple integrated chip, an application specific integrated circuit (ASIC), a field programmable gate array (FPGA), or any other suitable processing object, device, or component. Address bus 17 and data bus 15 are wires capable of carrying data (e.g. binary data). Alternatively, such wires may be replaced with any other suitable technology (e.g. optical radiation, laser technology, etc.) operable to facilitate the propagation of data.

Memory 14 is a storage element operable to maintain information that may be accessed by microprocessor 12. Memory 14 may be a random access memory (RAM), a read only memory (ROM), software, an algorithm, an erasable programmable ROM (EPROM), an electrically erasable programmable ROM (EEPROM), a fast cycle RAM (FCRAM), a static RAM (SRAM), or any other suitable object that is operable to facilitate such storage operations. In other embodiments, memory 14 may be replaced by another processor that is operable to interface with microprocessor 12.

For purposes of teaching and discussion, it is useful to provide some overview as to the way in which the following invention operates. The following foundational information may be viewed as a basis from which the present invention may be properly explained. Such information is offered earnestly for purposes of explanation only and, accordingly, should not be construed in any way to limit the broad scope of the present invention and its potential applications.

As outlined above, DSP systems consist of a number of multiplications of input data with constants, which are efficiently implemented in hardware as a set of additions and hardwired shifts. The hardware complexity can be further reduced by finding and eliminating common subexpressions among these operations. Conventional techniques find common subexpressions involving only a single variable at a time, and therefore are unable to do a good optimization of linear systems consisting of multiple variables like DCT and DFT.

Some systems have extended common subexpressions to include multiple variables by using rectangle-covering methods on a polynomial transformation of the linear systems. There are limitations to this method. The present invention proposes a new technique based on an iterative elimination of two-term common subexpressions, to overcome these limitations. The algorithm proposed herein is fast and, further, produces an implementation with the least number of additions/subtractions compared to other techniques. Synthesized examples show a significant reduction in the area and power consumption of these systems.

The format of the Specification is as follows. A brief example is offered for purposes of introducing the audience to the general concept of iterative optimizing using divisors, as proposed herein. This brief example is offered in the context of FIGS. 1-8. Subsequently, the theory and supporting documentation (inclusive of proofs, theorems, etc.) are provided to further elucidate the broad teachings of the present invention. Note that all such information has been offered for purposes of teaching only and, thus, should not be construed to limit or to restrict the broad teachings of the present invention.

Turning to the example, which is provided in conjunction with FIGS. 1-8, FIG. 2 is a simplified diagram that illustrates some example common subexpressions. Note that multiplications can be replaced with a set of shifts and addition operations, which are easier to perform. Hence, a circuit that is designed to achieve these results will be simpler and, furthermore, will consume less area and power. Multiplication operations are generally expensive in the context of processing. For example, considerable expense could be incurred during the design of a hardware block, as the area will be large. In such a case, the multiplication by a constant number (e.g. 5) can be simplified. Five can be represented as “0101” in a binary format and multiplication can be done using a single adder, which reduces complexity. In FIG. 2, there are two functions present (F₁ and F₂) and the objective is to implement both. If “7” and “13” are rewritten in a binary format, 0101 can be identified as the common digit pattern between “0111” and “1101”. This means that there is a common factor between these two functions. A new function (D₁) is then introduced. D₁ can then be used in the calculation of F₁ and F₂. This is illustrated by the equations of FIG. 2. In their original format, F₁ and F₂ required four additions, whereas now only three additions are needed. By reducing the number of additions, the power consumption, area, etc. are optimized.

FIG. 3 is a simplified diagram that illustrates a linear expression, which can be converted into a polynomial. Linear systems can be viewed as a set of arithmetic expressions consisting of +, −, and << operators. [The “<<” symbol connotes a shift. The designation of “Lⁱ” represents i bits shift to the left.] A methodology, in accordance with the present invention, can be implemented in order to extract common subexpressions. In this case, the number fourteen is written in binary (1110) and then multiplied by X, as is shown. In addition, utilization of the CSD format can achieve more optimization, as is explained more fully below.

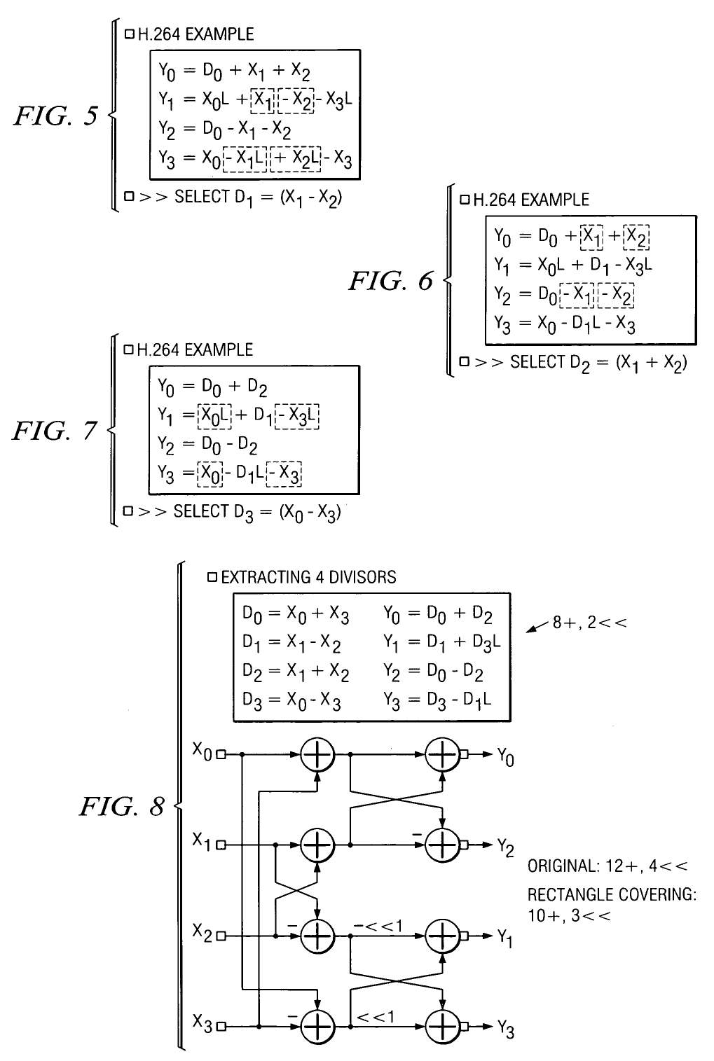

FIG. 4 is a simplified diagram that illustrates an example algorithm. The algorithm has four different functions (Y₀ to Y₃) in this H.264 example. A two-term common divisor is then identified. [Note that a complete definition for the term “divisor” is provided below.] One possible selection for these functions is X₀+X₃, which can be set to D₀. This designation can be used in the optimization. FIG. 5 is a simplified diagram that illustrates a subsequent step in the algorithm of FIG. 4. In this case, X₁−X₂ is a common subexpression between Y₁ and Y₃. This subexpression can be set to D₁. This designation of D₁ can be used in the optimization. FIG. 6 is a simplified diagram that illustrates a subsequent step in the algorithm of FIG. 5. In this case, another common subexpression is identified (X₁+X₂), which is set to D₂.

FIG. 7 is yet another simplified diagram that illustrates a subsequent step in the algorithm of FIG. 6. In this case, another common subexpression is identified (X₀−X₃), which is set to D₃. The functions can now be rewritten using D₃. FIG. 8 is a simplified diagram that illustrates an example result for the algorithm. Using the equations on the left-hand side of the FIGURE, the functions on the right hand side of the FIGURE are calculated. The original format for these functions had twelve additions and four shift operations. The new implementation has only eight additions/subtractions and only two shift operations. Hence, the complexity of these functions has been reduced significantly. Additionally, if the new format is used and a design hardware block is developed, its associated area will be smaller. In addition, the power consumption will also be less in such an environment.

Turning now to a discussion of the theoretical aspect of the present invention, using a given representation of the constant C, the multiplication with the variable X (assuming only a fixed-point representation) can be represented as

$$C * X = {\sum }_{i} \pm {XL}^{i} \qquad ( II )$$

where L represents the left shift from the least significant digit and the i's represent the digit positions of the non-zero digits of the constant, 0 being the digit position of the least significant digit. Each term in the polynomial can be positive or negative depending on the sign of the non-zero digit. For example the constant multiplication (6)_{decimal}*X=(10−10)_{CSD}*X=XL³−XL. In the case of real constants represented in fixed point, the constant can be converted into an integer and the final result can be corrected by shifting right. For example, the constant multiplication (0.101)_{binary}*X=(101)_{binary}*X*2⁻³=(X+XL²)*2⁻³. The linear system can be transformed using the equation as shown below:

$$\begin{matrix}{Y}_{0} = {X}_{0} + {X}_{1} + {X}_{2} + {X}_{3} \\ {Y}_{1} = {X}_{0} L + {X}_{1} - {X}_{2} - {X}_{3} L \\ {Y}_{2} = {X}_{0} - {X}_{1} - {X}_{2} + {X}_{3} \\ {Y}_{3} = {X}_{0} - {X}_{1} L + {X}_{2} L - {X}_{3}\end{matrix}$$

A two-term divisor of a polynomial expression is the result obtained after diving any two terms of the expression by their least exponent of L. This is equivalent to factoring by the common shift between the two terms. Therefore, the divisor is guaranteed to have at least one term with a zero power of L. A co-divisor of a divisor is the power of L that is used to divide the terms to obtain the divisor. A co-divisor is useful in dividing the original expression if the divisor corresponding to it is selected as a common subexpression. As an illustration of the divisor generating procedure, consider the expression Y₁ above. Consider the terms X₀L and −X₃L. The minimum exponent of L for these terms is L. Therefore, after dividing by L, we obtain the divisor (X₀−X₃) with co-divisor L. The other divisors generated for Y₁ are (X₀L+X₁), (X₀L−X₂), (X₁−X₂), (X₁−X₃L) and (−X₂−X₃L). All these divisors have co-divisors 1.

The importance of these two-term divisors is illustrated by the following theorem.

Theorem: There exists a multiple term common subexpression in a set of expressions if and only if there exists a non-overlapping intersection among the set of divisors of the expressions.

Algo 1. Algorithm to generate divisors for a set of expressions

```
Divisors({Pᵢ})
{
  {Pᵢ} = Set of expressions in polynomial form;
  {D} = Set of divisors and co-divisors = {Φ};
  for (every expression Pᵢ in {Pᵢ})
    {
      for (every pair of terms (tᵢ, tⱼ) in Pᵢ)
      {
        MinL = Minimum power of L in (tᵢ, tⱼ); // co-divisor
        tᵢ^{I} = tᵢ/MinL;
        tⱼ^{I} = tⱼ/MinL;
        d = (tᵢ^{I} + tⱼ^{I}); // divisor;
        {D} = {D} ∪ (d, MinL);
      }
    }
return {D};
}
```

This theorem basically states that there is a common subexpression in the set of polynomial expressions representing the linear system, if and only if there are at least two non-overlapping divisors that intersect. Two divisors are said to be intersecting if their absolute values are equal. For example, (X₁−X₂L) intersects both (−X₂L+X₁) and (X₂L−X₁). Two divisors are considered to be overlapping if one of the terms from which they are obtained is common. For example consider the following constant multiplication (10101)_{binary}*X, which is transformed to ₍₁₎X+₍₂₎XL²+₍₃₎XL⁴ in our polynomial representation. The numbers in parenthesis represent the term numbers in this expression. Now according to the divisor generating algorithm, there are two instances of the divisor (X+XL²) involving the terms (1, 2) and (2, 3), respectively. Now these divisors are said to overlap since they contain the term 2 in common. Two divisors are said to intersect, if they are the same, with or without reversing the signs of the terms. For example the divisor (X₁−X₂L) intersects with both (X₁−X₂L) and (−X₁+X₂L).

Proof:

(If)

If there is an M-way non-overlapping intersection among the set of divisors of the expressions, by definition it implies that there are M non-overlapping instances of a two-term subexpression corresponding to the intersection.

(Only if)

Suppose there is a multiple term common subexpression C, appearing N times in the set of expressions, where C has the terms {t₁, t₂, . . . tₘ}. Take any e={tᵢ, tⱼ}εC. Consider two cases. In the first case, if e satisfies the definition of a divisor, then there will be at least N instances of e in the set of divisors, since there are N instances of C and our divisor extraction procedure extracts all 2-term divisors. In the second case where e does not satisfy the definition of a divisor (there are no terms in e with zero power of L), there exists e¹={tᵢ¹, tⱼ¹} obtained (by dividing by the minimum power of L) which satisfies the definition of a divisor, for each instance of e. Since there are N instances of C, there are N instances of e, and hence there will be N instances of e¹ in the set of divisors. Therefore, in both cases, an intersection among the set of divisors will detect the common subexpression.

The iterative algorithm (shown in Algo2) is used for detecting and eliminating two-term common subexpressions. In the first step, frequency statistics of all distinct divisors are computed and stored. This is done by generating divisors {D_{new}} for each expression and looking for intersections with the existing set {D}. For every intersection, the frequency statistic of the matching divisor d₁ in {D} is updated and the matching divisor d₂ in {D_{new}} is added to the list of intersecting instances of d₁. The unmatched divisors in {D_{new}} are then added to {D} as distinct divisors.

In the second step of the algorithm, the best two-term divisor is selected and eliminated in each iteration. The best divisor is the one that has the most number of non-overlapping divisor intersections. Alternatively, one can use another criterion for choosing a divisor. The set of non-overlapping intersections is obtained from the set of all intersections by using an iterative algorithm in which the divisor instance that has the most number of overlaps with other instances in the set is removed in each iteration until there are no more overlaps. After finding the best divisor in {D}, the set of terms in all instances of the divisor intersections is obtained. From this set of terms, the set all divisors that are formed using these terms is obtained. These divisors are then deleted from {D}. As a result, the frequency statistics of some divisors in {D} will be affected, and the new statistics for these divisors is computed and recorded. New divisors are formed using the new terms formed during division of the expressions. The frequency statistics of the new divisors are computed separately and added to the dynamic set of divisors {D}.

In terms of algorithm complexity, the algorithm spends most of its time in the first step where the frequency statistics for all the distinct divisors in the set of expressions is computed. The second step of the algorithm is very fast (linear in the number of divisors) due to the dynamic management of the set of divisors. The worst-case complexity of the first step for an M×M constant matrix occurs when all the digits of each constant (assume N-digit representation) are non-zero. Each expression will consist of MN terms. Since the number of 2-term divisors is quadratic in the number of terms, the total number of divisors generated for each expression would be of O(M²N²). This represents the upper bound on the total number of distinct divisors in {D}. Assume that the data structure for {D} is such that it takes constant time to search for a divisor with given variables and exponents of L. Each time a set of divisors {D_{new}}, which has a maximum size of O(M²N²) is generated in Step 1, it takes O(M²N²) to compute the frequency statistics with the set {D}. Since this step is done M−1 times, the complexity of the first step is O(M³N²).

Algo 2. Extracting and eliminating common subexpressions

```
Optimize ({Pᵢ})
{
    {Pᵢ} = Set of expressions in polynomial form;
  {D} = Set of divisors = φ ;
  // Step 1. Creating divisors and their frequency statistics
  for each expression Pᵢ in {Pᵢ}
  {
        {D_{new}} = Divisors(Pᵢ);
        Update frequency statistics of divisors in {D};
        {D} = {D} ∪ { D_{new}};
  }
  //Step 2. Iterative selection and elimination of best divisor
  while (1)
  {
        Find d = divisor in {D} with most number
                of non-overlapping intersections;
        if (d == NULL) break;
        Divide affected expressions in {Pᵢ} by d;
      {d^{j}} = set of intersecting instances of d;
      for each instance d^{j} in {d^{j}}
          Remove from {D} all instances of divisors formed
          using the terms in d^{j};
        Update frequency statistics of affected divisors;
        {D_{new}} = Set of new divisors from new terms added
                by division;
        {D} = {D} ∪ {D_{new}};
  }
}
```

Applying the proposed technique to the set of expressions in FIG. 4 results in four common subexpressions (D₀−D₃) being detected. It can be seen that the common subexpressions D₁=(X₁+X₂) and D₂=(X₁−X₂) have instances that have their signs reversed (from above, D₁ is positive in Y₀ and negative in Y₂ and D₂ is positive in Y₁ and negative and shifted in Y₃).

In the context of minimum latency for a linear system, another aspect of the present invention involves delay. Assume that we are only interested in the fastest tree implementation of the set of additions and subtractions of a linear system. We assume that we have enough adders to achieve the fastest tree structure and achieve the minimum possible latency. When all the variables of the system are available at the same time (t=0), then the latency can be determined by the number of terms Nₘₐₓ of the longest expression in the system. The latency is then given by
Min-Latency=┌log₂ Nₘₐₓ┐ (I)

When the signals have different arrival times, even then, the latency can be calculated by Equation I, but the number of terms has to be adjusted to take into account the different availability times of the terms. We assume that the arrival times are integer numbers and that the delay of an adder/subtractor is one unit. For each term with arrival time tᵢ>0, we can view the term as being produced by the summation of 2^{t}^{ᵢ} dummy terms, which are available at time t=0 (the delay of the summation being tᵢ). Therefore, the number of terms for the expression is increased by 2^{t}^{ᵢ}−1. For example, consider the expression F=a+a<<2+a<<3+b+b<<2+b<<3+c+c<<2+d+e. 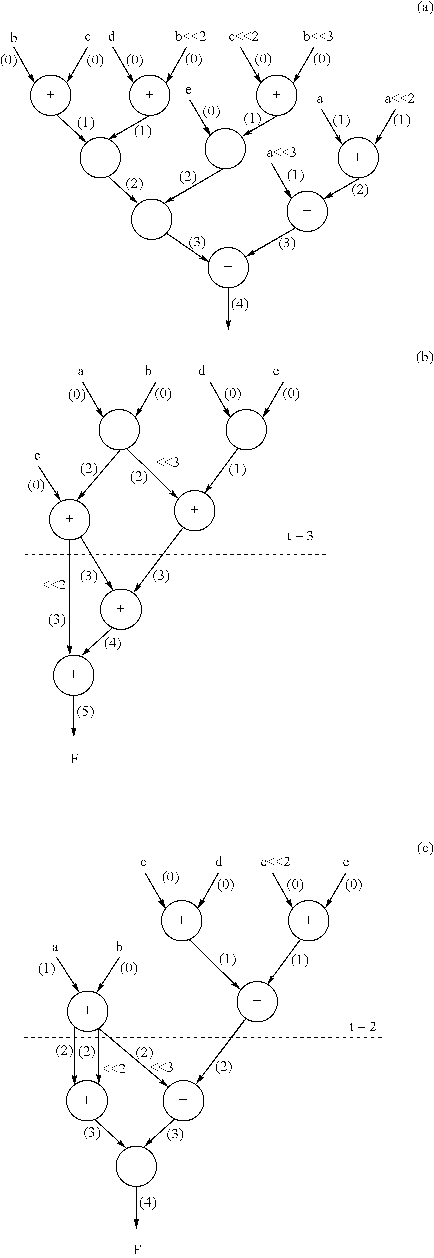
The arrival times of all the signals are shown along the edges of the graph. This expression has 10 terms, out of which three of them have arrival times equal to 1. Therefore the number of terms is calculated as 10+3*(2¹−1)=13. The minimum delay of the expressions calculated from Equation I is 4 units.
Theorem:

The minimum delay of the expressions as represented by Equation I, is the absolute lower bound for the delay, and eliminating common subexpressions can only increase the delay.

Proof:

We can prove this by contradiction. Assume that the delay of the longest expression, having M terms calculated by Equation I is d₁=┌log₂ M┐. This means that there is a fastest binary tree of height d₁ that can evaluate the longest expression.

Assume that after eliminating common subexpressions, the delay of the expressions is d₂<d₁. Now, even though the number of nodes in the graph are reduced as a result of subexpression sharing, the number of additions required to compute each expression does not change. Computation sharing just makes some of these additions common. Now according to our assumption, the longest expression can now be evaluated using a tree of height d₂<d₁. However, we know that we need a tree of height at least d₁=┌log₂ M┐ to add M terms. Hence, our assumption is false, and the theorem is proved.

A recursive common subexpression is a subexpression that contains at least one other common subexpression extracted before. For example, consider the constant multiplication (1010−101010−1)*X as shown in the equations below. The common subexpression d₁=X+X<<2 is non-recursive, and it reduces the number of additions by one. Now, the common subexpression d₂=(d₁<<2−X) is recursive since it contains the variable d₁ which corresponds to a previously extracted common subexpression. Extracting this leads to the elimination of one more addition.

$\begin{matrix}F = ( 1010 - 101010 - 1 ) X \\ = X << 10+X<<8-X<<6+X<<4+X<<2-X\end{matrix}$
(a) Original expression
$\begin{matrix}{d}_{1} = X + X << 2 \\ F = {d}_{1} << 8 + {d}_{1} << 2-X<<6-X\end{matrix}$
(b) Non-recursive common subexpression elimination
$\begin{matrix}{d}_{1} = X + X << 2 \\ {d}_{2} = {d}_{1} << 2-X \\ F = {d}_{2} << 6 + {d}_{2}\end{matrix}$
(c) Recursive common subexpression elimination

One problem that is being addressed by the present invention can be stated thus. Given a multiplierless realization of a linear system, minimize the number of additions/subtractions as much as possible such that the latency does not exceed the minimum specified latency. In this work, we constrain this latency to the minimum possible latency. As per the problem statement, we try to eliminate as many additions as possible by exploring even recursive common subexpression elimination.

The algorithm for delay aware common subexpression elimination is based on the algebraic method described above. The algorithm takes into account the effect of delay on selecting a particular divisor as a common subexpression. Only those instances of a divisor that do not increase the delay of the expression beyond the maximum specified delay limit are considered. We first describe how the delay of an expression on selection of divisor instances can be calculated. We then explain the main algorithm.

Throughout our algorithm, we assume that the delay of a single addition/subtraction is one time unit, and that the arrival times of the variables have been normalized to integer numbers.

Each divisor is associated with a level that represents the time (in integer units), when the value of the divisor is available. Each divisor is also associated with the number of original terms covered by it. To handle variables with different arrival times, we assume that each term available at time tᵢ is covered by 2ⁱ original dummy terms. This has no impact on the quality of the solution, and helps to predict the delay using a simple formula.

Consider the expression F as shown immediately below.

F = a⁽⁰⁾ + b⁽¹⁾ + c⁽²⁾ + d⁽⁰⁾
d₁ = (b⁽¹⁾ + c⁽²⁾)
Level (d₁) = 3
Original terms covered(d₂) = 2¹ + 2² = 6
d₂ = d₁ + a
Level(d₂) = 4
Original terms covered(d₂) = 6 + 1 = 7

The arrival times of the variables are shown as superscripts. The calculation of the level of the divisor and the original terms covered by the divisor is illustrated in the figure. The procedure for the calculation of the delay of an expression, after the selection of a divisor that is contained in the expression is illustrated in the notations below. The terms {T_{E}} of the expression are partitioned into the terms {T₁} covered by the divisor and the remaining terms {T₂}.

```
p = # of instances of Divisor D in expression
t = Delay(adder-steps) in computing divisor D
  {T₁} = current terms covered by ‘p’ instances of D
  {T_{E}} = current terms in the expression
  {T₂} = {T_{E}} − {T₁} = Remaining terms
  K = # of Values in {T₂} still available for computation
            after time t
Total values available = p + K
Delay of expression = (t + ┌log₂ (p + K)┐)
```

The delay is calculated from the number of values that are available for computation after the time (t) taken to compute the divisor under investigation. Among {T₁} terms, there will be ‘p’ values available corresponding to the ‘p’ instances of the divisor. We need to find the number of values from {T₂} that are available after time t. In general, we need to schedule the terms in {T₂} to get this information. But scheduling for every candidate divisor using a simple algorithm like As Soon As Possible (ASAP), which is quadratic in the number of terms is expensive. For many cases, we can estimate this number using a simple formula.

Let T₂ₒ be the number of original terms corresponding to the terms in {T₂}. If none of the terms in {T₂} have been covered by any divisor, or they are covered by divisors covering power of two original terms implemented in the fastest tree structure (covering 2^{j} original terms with delay j), then K can be quickly calculated using the formula

$$K = ⌈ \frac{{T}_{2 o}}{{2}^{t}} ⌉ \qquad ( IV )$$

The cases in which we can speedup the algorithm are:

1. The divisor covers power of 2 original terms with the fastest possible tree structure (2^{j} original terms with delay of j). In this case, we do not even need to estimate the delay, and all non-overlapping instances can be extracted without increasing the delay.

2. The remaining terms (terms not covered by the divisor) have not been covered by any other divisor.

3. Of the remaining terms (terms not covered by the divisor), some or all of the terms may be covered by divisors. If these divisors cover power of 2 original terms with the fastest possible tree structure, then the formula can be used.

Using these pruning conditions helps to significantly speed up the algorithm. If the terms in {T₂} do not satisfy this criterion, then K has to be calculated using ASAP (As Soon As Possible) Scheduling.

The delay calculation for the example expression is illustrated below. The delay calculation for divisor d₁=(a+b) is illustrated. The delay of this divisor is two units. We can see that four values are available for computation after one adder step. Three of them (p) correspond to the three uses of the divisor dᵢ and K=1 of them are from {T₂} (the terms other than those covered by d₁). K can also be calculated by the formula in Equation IV. The delay is calculated to be 4.

```
F = a + b + c + d + aL² + bL² + cL² + aL³ + bL³ + e
d₁ = (a⁽¹⁾ + b⁽⁰⁾): delay = t = 2
p = 3 instances of d₁ in F
  {T₁} = {a, b, aL², bL², aL³, bL³}
  {T₂} = {c, d, cL², e}
  K = 1
Delay = 2 + ┌log₂ (3 + 1)┐ = 4
(a) Selecting d₁ = (a + b)
F = d₁ + d₁L² + d₁L³ + c + d + cL² + e
d₂ = (d₁ + c): delay(d₂) = t = 3
p = 2
  {T₁} = {d₁, c, d₁L², cL²}
  {T₂} = {d, e, d₁L³}
  K = 1
Delay = 3 + ┌log₂ (2 + 1)┐ = 5
(b) Selecting d₂ = (d₁ + c)
```

The schematic above shows the delay calculation when d₂=(d₁+c) is selected. The delay of the divisor d₂ is three units. The number of values available for computation after t=3 adder steps is three. Two of them (p) correspond to the two uses of divisor d₂ and the other one (K) corresponds to the value e. K can also be calculated using equation IV. The delay is calculated to be 5.

The main algorithm is shown below. The algorithm consists of two steps. In the first step, frequency statistics of all the distinct divisors are computed and stored. This is done by generating divisors {D_{new}} for each expression and looking for intersections in the existing set {D} of generated divisors. For every intersection, the frequency statistic of the matching divisor d₁ in {D} is updated and the matching divisor d₂ in {D_{new}} is added to the list of intersecting instances of d₁. The unmatched divisors in {D_{new}} are then added to {D} as distinct divisors. In the second step of the algorithm, the best divisor is selected and eliminated in each iteration. We define the “best divisor” to be the divisor that has the most number of non-overlapping instances that do not increase the delay of the expressions beyond the maximum specified value. Alternatively, one can use other criteria to choose a good divisor. This value known as the true value is calculated for each distinct candidate divisor.

Algo 3. Simultaneous optimization of delay and number of operations

```
Optimize ({Pᵢ})
{
    {Pᵢ} = Set of expressions in polynomial form;
    {D} = Set o f divisors = φ ;
    // Step 1. Creating divisors and their frequency statistics
    for each expression Pᵢ in {Pᵢ}
    {
          {D_{new}} = Divisors(Pᵢ);
          Update frequency statistics of divisors in {D};
          {D} = {D} ∪ { D_{new}};
    }
  //Step 2. Iterative selection and elimination of best divisor
  MaxDelay = Maximum specified delay (adder steps) of
                expressions
  while (useful divisor available)
    {
        Find d = Divisor in {D} having the most number of
                  non-overlapping instances not increasing
                  the critical path;
        Rewrite all expressions using d;
        Update divisors in {D};
    }
  }
```

After extracting the best divisor, the expressions are rewritten using the divisor. Some divisors from {D} will be eliminated and some new divisors will be added, due to the rewriting of the expressions. The frequency statistics of the divisors will also change. All this is done dynamically in our algorithm.

For the previous example expression F shown above, assume that the maximum specified delay MaxDelay is 4 adder steps, which is equal to the critical path of the expression. The divisor d₁=(a+b) has three instances in F. The delay of the expression F is calculated to be 4 adder steps, after selecting d₁ as a common subexpression. This divisor is the best divisor and is selected. After rewriting F, the divisor d₂=(d₁+c) is examined. This divisor has 2 instances in F, but the delay of the expression is increased to 5 adder steps by choosing this divisor. Since the delay increases, it is not chosen.

Previous sections have described methods to optimize polynomial expressions and linear arithmetic expressions separately. An algorithm that can optimize constant multiplications in polynomial expressions can be very useful since many polynomial expressions consist of constant coefficients, which can be decomposed into shifts and additions. The CAX algorithm can be designed such that it can extract common computations in a set of expressions consisting of additions, subtractions, multiplications and shift operations. The first step of the algorithm is to transform the constant multiplications using the polynomial transformation (discussed above). There are two type of divisors discussed previously, single-cube divisors and double-cube divisors. Single-cube divisors are produced from each pair of distinct literals for every cube.

Double cube divisors are extracted from every pair of cubes of each expression. There are two different cases that need to be considered when generating two-cube divisors. In the first case, the two cubes under consideration have different variable cubes. Variable cube is the part of the cube consisting of only the variables (that is without the L exponent). For example in the cube ab²L², the cube ab² is its variable cube. When the two cubes under consideration have different variable cubes, then the divisor can be generated by just dividing by the biggest cube common to both cubes. For example in the expression shown below, the biggest cube common to both cubes of the expression is abL, and dividing by this cube gives the divisor (a+bL).

For the case when the cubes have the same variable cube, first a temporary divisor is created by dividing by the biggest common cube. Then this temporary divisor is multiplied by each distinct variable present in the two cubes. For example, in the expression abcL+abcL², shown in the equations below, the temporary divisor is (1+L). This is multiplied by each of the variables a, b, and c to get three different divisors.

```
  F = a²bL + ab²L²
  divisor = (a²bL + ab²L²)/(abL) = (a + bL)
(a) Divisor extraction from cubes with different variable cubes
  F = abcL + abcL²
  divisor_temp = (abcL + abcL²)/(abcL) = (1 + L)
  divisor₁ = a*(1 + L) = (a + aL)
  divisor₂ = b*(1 + L) = (b + bL)
  divisor₃ = c*(1 + L) = (c + cL)
(b) Divisor generation from cubes with same variable cubes
```

Each divisor has a value representing the savings in the number of operations by extracting the divisor. The extraction is carried out in an iterative manner, in which the divisor with the greatest value is extracted in each iteration.

As an example of the working of the technique, consider the two polynomial expressions P₁ and P₂ shown in the equations below. Using the transformation for constant multiplications, the expressions are transformed as shown. In the first iteration, the divisor d₁=(x+y) saves two additions and three multiplications, and is extracted. The expressions are rewritten as shown below. In the next iteration, the divisor d₂=(d₁L+y), which saves one addition and two multiplications is extracted. Finally the divisor d₃=(d₁+d₂L), saving one multiplication is extracted. The final optimized expressions are shown. These expressions consist of only two multiplications and three additions (shifts are generally free in hardware). The initial expressions had eight multiplications and two additions. There is no known optimization technique that can perform such optimizations on expressions consisting of additions, subtractions, multiplications and shift operations.

| | |
|---|---|
| P₁ = 5x² + 7xy | P₁ = x² + x² L² + xy + xyL + xyL² |
| P₂ = 4xy + 6y² | P₂ = xyL² + y²L + y²L² |
| (a) Set of polynomial | (b) Transforming the |
| expressions | constant multiplications |
| d₁ = (x + y) | d₁ = (x + y) |
| P₁ = xd₁ + xd₁L² + xyL | d₂ = d₁L + y |
| P₂ = yd₁L² + y²L | P₁ = xd₁ + xd₂L |
| | P₂ = yd₂L |
| (c) First iteration, extracting | (d) Second iteration, |
| d₁ = (x + y) | extracting d₂ = d₁L + y |

d₁ = (x + y)
d₂ = d₁ << 1 + y
d₃ = d₁ + d₂ << 1
P₁ = x * d₃
P₂ = y * d₂ << 1
(e) Final implementation after extracting d₃ = (d₁ + d₂ << 1)

A popular technique for computing large integer exponents is the method of squaring. The squaring method does not consider the common computations in the exponentiation. These common computations can be found by finding common binary patterns in the binary representation of the constant. The common binary patterns can be found by using the CAX algorithm. As an example, consider the exponentiation a²⁷. The binary form of the exponent is (11011). Common patterns can be found by expanding the constants using the polynomial transformation with the variable L, and extracting matching divisors.

a²⁷ = a⁽¹¹⁰¹¹⁾
11011 = 1 + L + L³ + L⁴
extracting d₁ = (1 + L),
11011 = d₁ + d₁L³

The schematic above shows the extraction of the common bit pattern “11” from the binary pattern “11011.” This can reduce the number of multiplications required for the computation. The schematic below shows the computation using the popular method of squaring, which requires seven multiplications. This also shows the computation that utilizes the common computation and requires one fewer multiplication.

| | |
|---|---|
| t₁ = a * a → a² | d₁ = a * a → a² |
| t₂ = t₁ * a → a³ | d₂ = d₁ * a → a³ (common subexpression) |
| t₃ = t₂ * t₂ → a⁶ | t₁ = d₂ * d₂ → a⁶ |
| t₄ = t₃ * t₃ → a¹² | t₂ = t₁ * t₁ → a¹² |
| t₅ = t₄ * a → a¹³ | t₃ = t₂ * t₂ → a²⁴ |
| t₆ = t₅ * t₅ → a²⁶ | t₄ = t₃ * d₂ → a²⁷ |
| t₇ = t₆ * a → a²⁷ | |
| (a) Computing a²⁷ using | (b) Computing a²⁷ using |
| method of squares | the common subexpression |

In another aspect of the present invention, an algorithm for three-term extraction is provided in Algo 4. The algorithm can be used to optimize a linear system to be synthesized using Carry Save Adders (CSAs). A Carry Save Adder is a fast adder, which takes three inputs and adds them and generates two outputs, sum and carry which should be added to generate final result. In the first step, frequency statistics of all distinct divisors is computed and stored. By frequency statistics, we mean the number of instances of each distinct divisor. This is done by generating divisors {D_{new}} for each expression and looking for intersections with the existing set {D}. For every intersection, the frequency statistic of the matching divisor d₁ in {D} is updated and the matching divisor d₂ in {D_{new}} is added to the list of intersecting instances of d₁. The unmatched divisors in {D_{new}} are then added to {D} as distinct divisors.

Algo 4. Algorithm for three term extraction

```
Optimize ({Pᵢ})
{
  {Pᵢ} = Set of expressions in polynomial form;
  {D} = Set of divisors = φ ;
  // Step 1. Creating divisors and their frequency statistics
  for each expression Pᵢ in {Pᵢ}
  {
    {D_{new}} = Divisors(Pᵢ);
    Update frequency statistics of divisors in {D};
    {D} = {D} ∪ { D_{new}};
  }
  //Step 2. Iterative selection and elimination of best divisor
  while (1)
  {
    Find d = divisor in {D} with most number
          of non-overlapping intersections;
    if (d == NULL) break;
    Rewrite affected expressions in {Pᵢ} using d;
    Remove divisors in {D} that have become invalid;
    Update frequency statistics of affected divisors;
    {D_{new}} = Set of new divisors from new terms added
          by division;
      {D} = {D} ∪ {D_{new}};
    }
  }
```

In the second step of the algorithm, the best three-term divisor is selected and eliminated at each iteration. The best divisor is the one that has the most number of non-overlapping divisor intersections. Alternatively, one can use other criteria for choosing a divisor. Those expressions that contain this best divisor are then rewritten. Consider the following set of expressions

$$\begin{matrix}{Y}_{1} = {X}_{1} + X 1 ⪡ 2 + {X}_{2} + {X}_{2} ⪡ 1 + {X}_{2} ⪡ 2 \\ {Y}_{2} = {X}_{1} ⪡ 2 + {X}_{2} ⪡ 2 + {X}_{2} ⪡ 3\end{matrix}$$

High speed implementation of these expressions requires four Carry Save Adders (CSAs) and two fast adders. The number of CSAs can be reduced by extracting and eliminating common three term subexpressions. From the above expressions, the common expression D₁=X₁+X₂+X₂<<1 can be detected. Since each carry save adder (CSA) produces two outputs, a sum and a carry, each divisor also produces two numbers representing the two outputs. The subsequent set of equations show the rewriting of the expressions after the selection of the subexpression D₁=X₁+X₂+X₂<<1, where D₁ is the extracted divisor, and D₁^{S} and D₁^{C} represent the sum and the carry outputs of D₁, respectively.

After selecting the best divisor, those divisors that overlap with it, no longer exist and have to be removed from the dynamic list {D}. As a result, the frequency statistics of some divisors in {D} will be affected, and the new statistics for these divisors is computed and recorded. New divisors are generated for the new terms formed during division of the expressions. The frequency statistics of the new divisors are computed separately and added to the dynamic set of divisors {D}.

The algorithm terminates when there are no more useful divisors. For our example expressions, after rewriting the expressions as shown in the subsequent set of equations, the set of dynamic divisors {D} is updated. No more useful divisors are found after this, and the algorithm terminates. The optimized example is below.

$$\begin{matrix}{D}_{1} = {X}_{1} + {X}_{2} + {X}_{2} ⪡ 1 \\ {Y}_{1} = ( {D}_{1}^{S} + {D}_{1}^{C} ) + {X}_{1} ⪡ 2 + {X}_{2} ⪡ 2 \\ {Y}_{2} = ( {D}_{1}^{S} + {D}_{1}^{C} ) ⪡ 2\end{matrix}$$

In terms of algorithm complexity and quality, the algorithm spends most of its time in the first step where the frequency statistics of all distinct divisors are computed and stored. For an expression with N terms, the number of three-term divisors is T(N³). Therefore, the complexity of the first step, for the case of M expressions is T(MN³). In the second step of the algorithm, each time a divisor is selected, the number of terms in the affected divisor is reduced by one. In the worst case, all expressions are reduced from N terms to two terms at the end of the algorithm. The number of steps to reduce from N terms to two terms is (N−2). Since there are M expressions, the complexity of this step is T(MN).

The three-term extraction algorithm presented above did not consider the impact of the optimizations on the total delay of the CSA tree. However, performing extraction among the expressions can create certain dependencies among the signals that can cause the overall delay to increase. This delay can be reduced by reversing some of the optimizations using algorithms such as Tree Height Reduction (THR), but these algorithms involve extensive backtracking and hence are very expensive. Instead, the delay can be controlled during the extraction algorithm.

We use a unit delay for both the sum and the carry outputs of a CSA, and use integer numbers for the arrival times of the various signals in the circuits. This model can be easily generalized to handle actual values for arrival times and delays of the CSAs. This presents an optimal polynomial time algorithm for finding the fastest CSA tree for every expression. This algorithm is an iterative algorithm where in each step the terms of the expression are sorted according to non-decreasing availability times. The first three terms are then allotted to a CSA. This continues until only two terms remain.

We use this algorithm to find the minimum delay of given expressions, using the delay model. We then perform extraction, such that at each step, the delay of the expressions does not exceed this minimum delay.

Consider the evaluation of the following arithmetic expressions,
F₁=a+b+c+d+e
F₂=a+b+c+d+f
Arrival times (a,b,c,d,e,f)={2,0,0,0,0,0}

All signals are available at time t=0, except for a, which is available at time t=2.

Using the optimal CSA allocation algorithm, the minimum delay for both F₁ and F₂ is calculated as 3+D(Add), where D(Add) is the delay of the final two input adder.

The set of equations below show the evaluation of the two expressions after performing delay ignorant extraction. In this example provided below, the subexpression D₁=(a+b+c) is first extracted and then the subexpression D₂=D₁^{S}+D₁^{C}+d is extracted. This leads to an implementation with only four CSAs and two 2-input adders, but the delay of the circuit is now 5+D(Add), which is two units more than the optimal delay.
D₁=a+b+c
Delay(D₁)=3
F₁=D₁^{S}+D₁^{C}+d+e
F₂=D₁^{S}+D₁^{C}+d+f
Delay(F₁,F₂)=5+D(Add)
D₂=D₁^{S}+D₁^{C}+d
Delay(D₂)=4
F₁=D₂^{S}+D₂^{C}+e
F₂=D₂^{S}+D₂^{C}+f
Delay(F₁,F₂)=5+D(Add)
D₁=b+c+d
Delay(D₁)=1
F₁=D₁^{S}+D₁^{C}+e+a
F₂==D₁^{S}+D₁^{C}+f+a
Delay(F₁,F₂)=3+D(Add)

The next set of equations show the result of delay aware extraction. Here, the subexpression (a+b+c) is not extracted because by doing so the delay increases. The divisor D₁=(b+c+d) does not increase the delay so it is extracted. After rewriting the expressions, the common subexpression (D₁^{S}+D₁^{C}+a) is considered, but is not selected because it increases the delay. The delay aware extraction has one more CSA than the delay ignorant one, but it has the minimum delay.

The delay aware extraction algorithm is a modification of the original algorithm that does not consider delay. Instead of finding the divisor that has the most number of non-overlapping instances, the divisor that has the most number of non-overlapping instances that do not increase the minimum delay is selected. This requires that the delay be calculated for every candidate divisor. The complexity of calculating the delay of an expression using the previously disclosed algorithm is quadratic in the number of terms in the expression.

Some of the steps illustrated in the preceding FIGURES may be changed or deleted where appropriate and additional steps may also be added to the proposed process. These changes may be based on specific system architectures or particular arrangements or configurations and do not depart from the scope or the teachings of the present invention. It is also critical to note that the preceding description details a number of techniques for reducing operations. While these techniques have been described in particular arrangements and combinations, system 10 contemplates using any appropriate combination and ordering of these operations to provide for decreased operations in linear system 20. As discussed above, identification of the common subexpressions may be facilitated by rectangle covering, ping-pong algorithms, or any other process, which is operable to facilitate such identification tasks. Considerable flexibility is provided by the present invention, as any such permutations are clearly within the broad scope of the present invention.

Although the present invention has been described in detail with reference to particular embodiments illustrated in FIGS. 1 through 8, it should be understood that various other changes, substitutions, and alterations may be made hereto without departing from the spirit and scope of the present invention. For example, although the present invention has been described with reference to a number of elements included within system 10, these elements may be rearranged or positioned in order to accommodate any suitable processing and communication architectures. In addition, any of the described elements may be provided as separate external components to system 10 or to each other where appropriate. The present invention contemplates great flexibility in the arrangement of these elements, as well as their internal components. Moreover, the algorithms presented herein may be provided in any suitable element, component, or object. Such architectures may be designed based on particular processing needs where appropriate.

Numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. A method for reducing operations in a processing environment, comprising:
generating one or more binary representations, wherein one or more of the binary representations are included in one or more linear equations that include one or more operations;
converting one or more of the linear equations to one or more polynomials; and
identifying one or more common subexpressions associated with the polynomials in order to reduce one or more of the operations, wherein the identifying is facilitated by an algorithm that iteratively selects divisors and then uses the divisors to eliminate common subexpressions among the linear equations.

2. The method of claim 1, wherein one or more of the operations relate to subtraction, addition, shifting, or multiplication.

3. The method of claim 1, wherein one or more of the linear equations are associated with Discrete Cosine Transforms (DCT), Inverse Discrete Cosine Transforms (IDCT), Discrete Fourier Transforms (DFT), Discrete Sine Transforms (DST), or Discrete Hartley Transforms (DHT).

4. The method of claim 1, wherein instead of the linear equations, a set of polynomials are optimized.

5. The method of claim 1, wherein at least one of the divisors is a two-term divisor.

6. The method of claim 1, further comprising:
identifying one or more of the common subexpressions by extracting common bit patterns among constants multiplying a single variable.

7. The method of claim 1 further comprising:
identifying one or more of the common subexpressions by extracting common bit patterns among constants multiplying multiple variables.

8. The method of claim 1, wherein a delay of calculating expressions is evaluated when the optimization is performed.

9. The method of claim 1, wherein three-term divisors are used and each of the three-term divisor is calculated using a Carry Save Adder which generates two outputs.

10. The method of claim 9, wherein the divisors with a highest number of non-overlapping intersections are selected.

11. The method of claim 1, wherein the divisors which do not increase the delay of expressions are selected.

12. The method of claim 11, wherein the algorithm includes a delay calculation speed up.

13. The method of claim 1, wherein the algorithm includes operations that optimize exponents.

14. A system for reducing operations in a processing environment, comprising:
means for generating one or more binary representations, wherein one or more of the binary representations are included in one or more linear equations that include one or more operations;
means for converting one or more of the linear equations to one or more polynomials; and
means for identifying one or more common subexpressions associated with the polynomials in order to reduce one or more of the operations, wherein the identifying is facilitated by an algorithm that iteratively selects divisors and then uses the divisors to eliminate common subexpressions among the linear equations.

15. The system of claim 14, wherein one or more of the operations relate to subtraction, addition, shifting, or multiplication.

16. The system of claim 14, wherein one or more of the linear equations are associated with Discrete Cosine Transforms (DCT), Inverse Discrete Cosine Transforms (IDCT), Discrete Fourier Transforms (DFT), Discrete Sine Transforms (DST), or Discrete Hartley Transforms (DHT).

17. The system of claim 14, wherein instead of the linear equations a set of polynomials are optimized.

18. The system of claim 14, wherein a delay of calculating expressions is evaluated when the optimization is performed.

19. The system of claim 14, further comprising:
identifying one or more of the common subexpressions by extracting common bit patterns among constants multiplying a single variable.

20. The system of claim 14, further comprising:
generating a resultant, for one or more of the linear equations, based on the reduction in the operations.

21. The system of claim 14, wherein three-term divisors are used and each of the three-term divisor is calculated using a Carry Save Adder which generates two outputs.

22. The system of claim 14, wherein the divisors with a highest number of non-overlapping intersections are selected.

23. The system of claim 14, wherein the divisors which do not increase the delay of expressions are selected.

24. The system of claim 14, wherein the algorithm includes a delay calculation speed up.

25. The system of claim 14, wherein the algorithm includes operations that optimize exponents.

26. Software for reducing operations in a processing environment, the software being embodied in a computer readable medium and comprising computer code such that when executed is operable to:
generate one or more binary representations, wherein one or more of the binary representations are included in one or more linear equations that include one or more operations;
convert one or more of the linear equations to one or more polynomials; and
identify one or more common subexpressions associated with the polynomials in order to reduce one or more of the operations, wherein the identifying is facilitated by an algorithm that iteratively selects divisors and then uses the divisors to eliminate common subexpressions among the linear equations.

27. The medium of claim 26, wherein one or more of the operations relate to subtraction, addition, shifting, or multiplication.

28. The medium of claim 26, wherein instead of the linear equations a set of polynomials are optimized.

29. The medium of claim 26, wherein a delay of calculating expressions is evaluated when the optimization is performed.

30. The medium of claim 26, wherein the code is further operable to:
identify one or more of the common subexpressions by extracting common bit patterns among constants multiplying a single variable.

31. The medium of claim 26, wherein the code is further operable to:
identify one or more of the common subexpressions by extracting common bit patterns among constants multiplying multiple variables.

32. The medium of claim 26, wherein the code is further operable to:
generate a resultant, for one or more of the linear equations, based on the reduction in the operations.

33. The medium of claim 26, wherein at least one of the divisors is a two-term divisor.

34. The medium of claim 26, wherein three-term divisors are used and each of the three-term divisor is calculated using a Carry Save Adder which generates two outputs.

35. The medium of claim 26, wherein the divisors with a highest number of non-overlapping intersections are selected.

36. The medium of claim 26, wherein the divisors which do not increase the delay of expressions are selected.

37. The medium of claim 26, wherein the algorithm includes a delay calculation speed up.

38. The medium of claim 26, wherein the algorithm includes operations that optimize exponents.
